(19) United States
(12) Patent Application Publication
(10) Pub. No.: US 2015/0348419 A1
(43) Pub. Date: Dec. 3, 2015

(54) METHOD OF ASSIGNING PLANNED PATHS TO MULTIPLE MACHINES TO COOPERATIVELY COVER AREA

(71) Applicants: Paul MATTHEWS, (US); AGCO CORPORATION, Duluth, GA (US)

(72) Inventor: Paul Ross MATTHEWS, Bayern (DE)

(73) Assignee: AGCO Corporation, Duluth, GA (US)

(21) Appl. No.: 14/654,921

(22) PCT Filed: Dec. 26, 2013
(86) PCT No.: PCT/US2013/077763

§ 371 Date: Jun. 23, 2015

Related U.S. Application Data
(60) Provisional application No. 61/746,689, filed on Dec. 28, 2012.

(51) Int. Cl. G08G 1/00; A01B 69/00; G01C 21/00

(52) U.S. Cl. CPC G08G 1/20; G01C 21/00; A01B 69/00

(57) ABSTRACT

A method includes providing proximally in time over a wireless medium a first plurality of different just-in-time wayline segments for a given field to a plurality of agricultural machines, respectively, at least one of the different just-in-time wayline segments separated from another of the different just-in-time wayline segments by a length greater than one of the plurality of agricultural machines. Status updates are received from the plurality of agricultural machines and responsive to the status updates, a second plurality of different just-in-time wayline segments for the field to at least a portion of the plurality of agricultural machines are provided over the wireless medium.

### CROSS REFERENCE TO RELATED APPLICATIONS

This application is a national phase application of international patent application number PCT/US2013/077763, filed Dec. 26, 2013, which claims priority to U.S. provisional application Ser. No. 61/746,689, filed Dec. 28, 2012. The full disclosures, in their entireties, of international patent application number PCT/US2013/077763 and U.S. provisional application No. 61/746,689 are hereby incorporated by reference.

### TECHNICAL FIELD

The present disclosure is generally related to agriculture technology, and, more particularly, computer-assisted farming.

### BACKGROUND

Recent efforts have been made to automate or semi-automate farming operations. Such efforts serve not only to reduce operating costs but also improve working conditions on operators and reduce operator error, enabling gains in operational efficiency and yield. For instance, agricultural machines may employ a guidance system to reduce operator fatigue and costs.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a schematic diagram that illustrates an example network topology for an embodiment of a dynamic planning system where a master node is located remotely from a plurality of slave-configured agricultural machines in a field.

FIG. 1B is a schematic diagram that illustrates an example network topology for an embodiment of a dynamic planning system where a master node is located in a master-configured agricultural machine and is communicatively coupled to a plurality of slave-configured agricultural machines, wherein all of the agricultural machines are located in the same field.

FIG. 1C is a schematic diagram that illustrates an example network topology for an embodiment of a dynamic planning system where a master node is located in a master-configured agricultural machine and is communicatively coupled to a plurality of slave-configured agricultural machines in an ad hoc network.

FIG. 2 is a schematic diagram that illustrates an embodiment of a dynamic planning system with a plurality of agricultural machines receiving just-in-time wayline segments.

FIG. 3A is a block diagram showing an embodiment of a control system that includes a master node of an embodiment of a dynamic planning system.

FIG. 3B is a block diagram showing an embodiment of a controller for the control system of FIG. 3A.

FIG. 4 is a flow diagram that illustrates an example embodiment of a dynamic planning method.

FIG. 5 is a flow diagram that illustrates another example embodiment of a dynamic planning method.

### DESCRIPTION OF EXAMPLE EMBODIMENTS

### Overview

In one embodiment, a method comprising providing proximally in time over a wireless medium a first plurality of different just-in-time wayline segments for a given field to a plurality of agricultural machines, respectively, at least one of the different just-in-time wayline segments separated from another of the different just-in-time wayline segments by a length greater than one of the plurality of agricultural machines; receiving status updates from the plurality of agricultural machines; and responsive to the status updates, providing over the wireless medium a second plurality of different just-in-time wayline segments for the field to at least a portion of the plurality of agricultural machines.

### DETAILED DESCRIPTION

Certain embodiments of dynamic planning systems and methods are disclosed that enable the assignment of multiple paths to multiple agricultural machines such that the agricultural machines can work together on the same task (e.g., harvesting crop material in a field, planting, seeding, etc.), yet on different parts of a field. In one embodiment, a dynamic planning system provides for real-time sharing of just-in-time, planned paths or segments, enabling each agricultural machine in a given field to react to changes in conditions and/or events and be apprised of real-time updates from other agricultural machines in the field and the progress made in achieving work completion of the given task. After the transmission of an initial set of just-in-time wayline segments, status updates are received by a master node and used to determine just-in-time wayline segments (e.g., that previously had not yet been defined and/or assigned for a given machine) for subsequent transmission and hence continued processing of the field.

Digressing briefly, auto-guidance systems are fairly commonplace to increase the accuracy of the task at hand, reduce operator fatigue, and/or reduce overlap (or underlap) of operations. Such guidance systems typically work by one machine defining a method of traversing a field (e.g., parallel or contour waylines) and then manually sharing the data with other machines via such mechanisms as removable storage (e.g., USB sticks, SD cards, etc.). While such methods permit multiple machines to operate in the same work area/field, these conventional methods are also rather inflexible. For instance, such conventional methods include constraints that deem the only way to traverse the field and still maintain auto-guidance is to follow the prescribed wayline throughout the field. Also, such methods may not enable operators to see the completed (or incompleted) work by other agricultural machines. In some conventional systems, the wayline determinations are successive and proximate, depending on a prior wayline determination (e.g., based on header width and the prior wayline). One or more embodiments of dynamic planning systems address one or more of these shortcomings of conventional systems by having a designated master node coordinate the resource planning for a particular field. Such resource planning may include the quantity of agricultural machines used to work the field and their associated characteristics (e.g., capacity, implement specifications, etc.), the overall plan for how the field is to be worked, the just-in-time wayline data for each agricultural machine, and/or the work completed by each agricultural machine.

The generation of wayline data includes data points associated with a path to be worked, and may include using a worked edge (and unworked edges) as a basis for the wayline generation. As is known, data points may be established by a previous pass of the field by the agricultural machine (and/or other agricultural machine), and the adherence to the various paths may be achieved through the implementation, in whole or in part, by an auto-guidance system, or simply, guidance system (e.g., using a global navigation satellite systems (GNSS), such as global positioning systems (GPS), GLONASS, Galileo, among other constellations). For instance, an agricultural machine, such as a combine harvester, may traverse a field row collecting crop material, and a guidance system, such as a Global Positioning System (GPS) on the combine harvester, may record the path followed along with additional data such as the harvester's speed, direction, amount of crop material collected, and fuel remaining. Similarly, other machines, such as a planter or sprayer may record data such as remaining supply volume of their respective consumables (e.g., seeds, water, herbicides, and/or pesticides). Such data may be stored at a master node, and used in resource planning and/or in the determination of just-in-time wayline segments. The data points may be used as a general plan of coverage, from which the just-in-time wayline segments are at least partially based as status updates are received and processed by a master node. The location of each data point may be adjusted by an offset amount to compensate for the location of the guidance system component in relation to the work area covered by the machine. For example, a combine harvester may navigate such that one edge of the working header follows an existing wayline while new data points are generated with coordinates associated with the opposite edge of the header. Additional information on wayline generation using a working edge and a header or other implement width may be found in commonly-assigned patent application publication 20110160961. In some embodiments, the generation of a just-in-time wayline may be for agricultural machines that are located in separate and/or disparate regions or areas of a given field (e.g., all or a portion of the waylines provided at any given time as part of a transmission over a network displaced from each other by more than a width or length of the agricultural machine, including the implement width or length). In other words, the derivation or determination of a given just-in-time wayline need not depend on a prior-determined, just-in-time wayline (and header width), but rather, may be determined independently. In some embodiments, a combination of dependent and independent just-in-time waylines may be determined for a given field.

Having summarized certain features of dynamic planning systems of the present disclosure, reference will now be made in detail to the description of the disclosure as illustrated in the drawings. While the disclosure will be described in connection with these drawings, there is no intent to limit it to the embodiment or embodiments disclosed herein. For instance, in the description that follows, one focus is on an agricultural machine embodied as a combine harvester, though it should be appreciated that some embodiments of dynamic planning system may use other machines, towed or self-propelled, and hence are contemplated to be within the scope of the disclosure. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

Note that references hereinafter made to certain directions, such as, for example, “front”, “rear”, “left” and “right”, are made as viewed from the rear of the combine harvester looking forwardly.

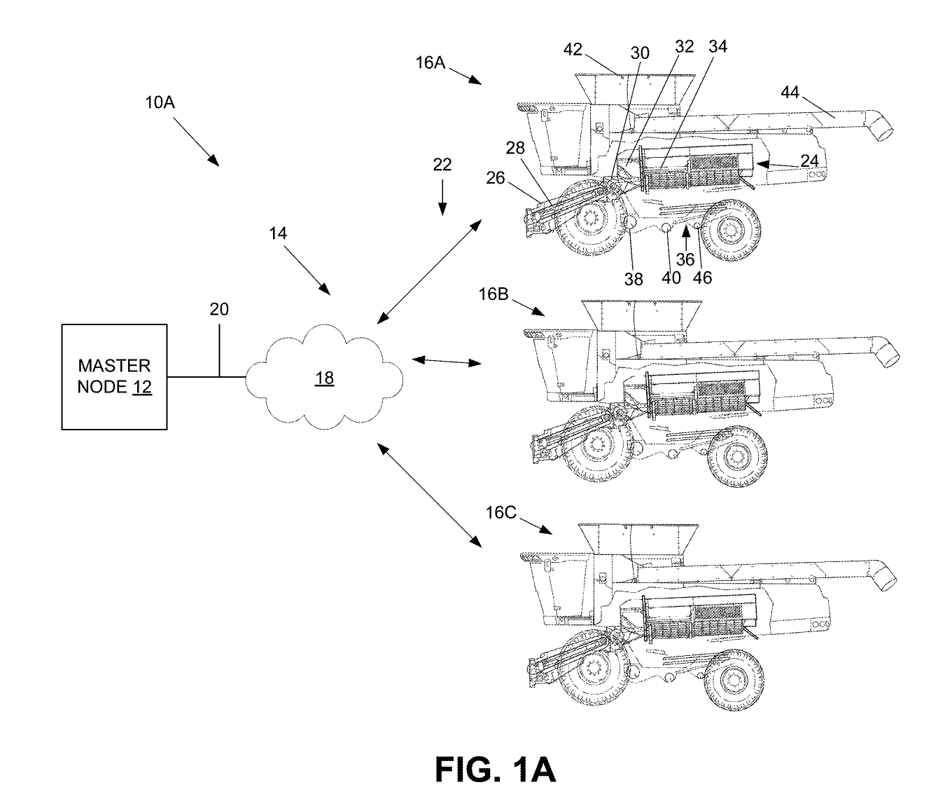

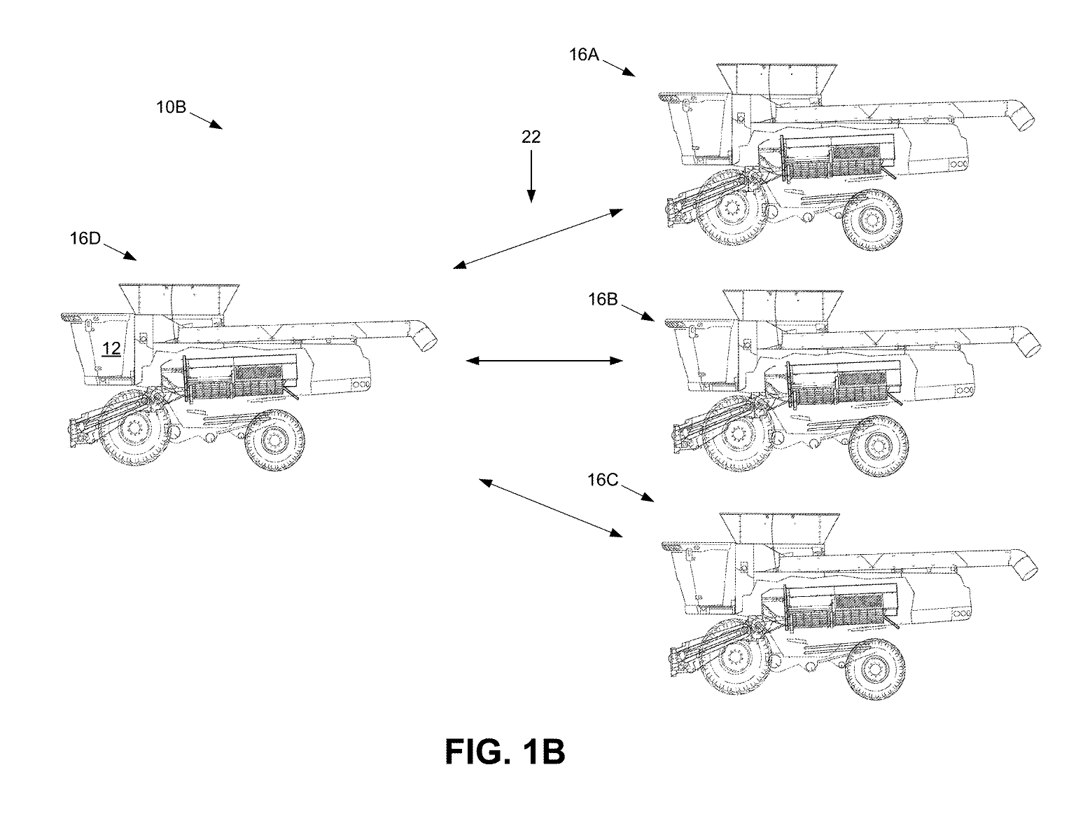

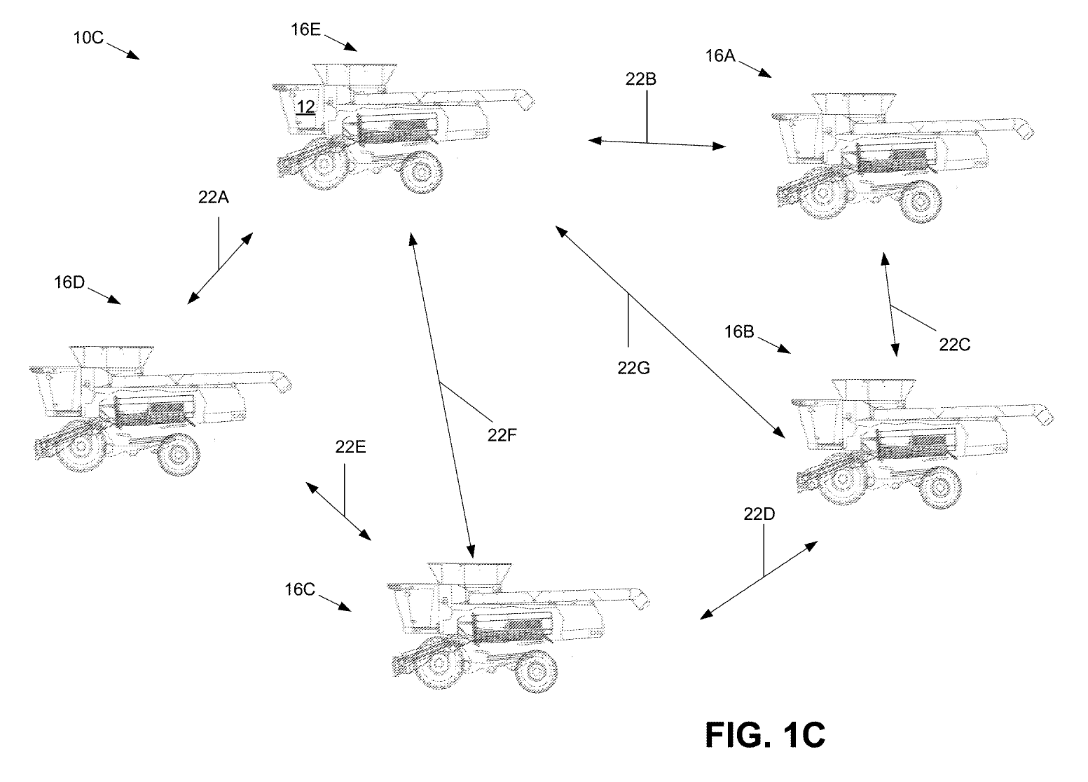

Referring now to FIG. 1A, shown is a schematic diagram that illustrates an example network topology for an embodiment of a dynamic planning system 10A, which includes a master node 12 located remotely from a worked field and communicatively coupled over a network 14 to a plurality of agricultural machines embodied as combine harvesters 16 (e.g., 16A, 16B, and 16C), each in a slave-node configuration relative to the master node 12. It should be appreciated within the context of the present disclosure that, though shown with combine harvesters 16, some embodiments may utilize other agricultural machines (e.g., with or without combine harvesters) and hence are contemplated to be within the scope of the disclosure. Further, it is noted that the combine harvesters 16 are shown in FIGS. 1A-1C without the attached header for purposes of brevity, with the understanding that one of a plurality of different types of headers may be used with each of the combine harvesters 16.

The master node 12 may be a server, computer (e.g., personal computer), or other type of computing device and/or software that is located at a business (e.g., farm) management office, or other locations remote from the field. As described below, some embodiments of dynamic planning systems 10 may employ a master node 12 in one of the combine harvesters 16 in the field. The master node 12 computes just-in-time wayline segments for each combine harvester 16, and transmits (including causing to be transmitted, such as via an integrated or externally-coupled transceiver) the wayline segments over the network 14 to the combine harvesters 16 for use in a defined area of the field. In one embodiment, the just-in-time wayline segments comprise waylines that represent a small portion or subset of an operation, such as the area proximal to the combine harvester 16 and two hundred (200) meters ahead of the recipient combine harvester 16, as opposed to the entire field. For instance, in one embodiment, a just-in-time wayline is a truncated version or subset of a traditional wayline, enabling more flexibility in dynamically assigning and hence planning the operations among a plurality of agricultural machines in a field. In some embodiments, the area beyond the segment (e.g., beyond 200 meters in one example) is undefined until the status updates are received from the respective combine harvesters 16 in the field, after which the next set of just-in-time wayline segments are determined. In some embodiments, the wayline segments are determined for subsequent areas of the field but unassigned until the status updates are received.

As each combine harvester 16 progresses through their respective assigned segment and associated task, status updates are transmitted from the combine harvester 16 to the master node 12 (via the network 14) so that the master node 12 may be apprised of the extent of task completion (and machine conditions) for not only each combine harvester 16, but also the collective group of combine harvesters 16 in the field. Stated otherwise, the master node 12 receives over the network 14, from each of the combine harvesters 16, status updates. The status updates include information about the progress the respectively transmitting combine harvester 16 has made toward the task associated with the respectively transmitted just-in-time wayline. The status updates may also include information corresponding to whether the combine harvester 16 has traversed the field in a manner other than required by the transmitted just-in-time wayline (e.g., via operator intervention to circumvent an obstacle in the field, including a wet area or water course or environmentally sensitive area), the location of combine harvester 16 (singly and with respective to other combine harvesters 16 in the field), and operating parameters of the combine harvester 16 (e.g., whether the combine harvester becomes inoperable, capacity of the grain bin, fuel use information, speed, direction, etc.).

For instance, if a combine harvester 16 breaks down (e.g., becomes inoperable) or a change in field conditions warrants that the operator cause the associated machine to traverse the field in a different manner, data (e.g., a status update) is fed back to the master node 12, which can responsively re-assign just-in-time waylines based on the updated information. In other words, if the combine harvester 16A breaks down, the just-in-time wayline (or a portion thereof) assigned to the combine harvester 16A may be transmitted to another one of the combine harvesters, such as the single combine harvester 16B (or cooperatively, plural combine harvesters 16B and 16C) for completion. Similarly, if operator intervention causes a deviation from the planned path (e.g., according to the transmitted just-in-time wayline segment), the status update apprising of the deviation from plan may be used to alter the determination and transmission of the next set of just-in-time wayline segments.

In one embodiment, the master node 12 communicates the status updates received from each of the combine harvesters 16 and forwards the status updates to the other combine harvesters in, or slated to be in, the field, enabling each combine harvester 16 to have an overview or assessment of operations occurring among all of the combine harvesters 16 (and possibly other vehicles) in the field. Having the overall scope of field operations at any given combine harvester 16 enables field report generation from either one of the combine harvesters 16. In other words, with all of the data from each of the combine harvesters shared across the entire fleet of machines in the field, an operations manager need not consolidate data from each respective combine harvester 16 to demonstrate completion of the operation for, say, billing purposes for a customer (e.g., in a contract situation). The consolidation of operation data results in facilitated reporting.

It should be appreciated within the context of the present disclosure that the communication of data is described using the combine harvesters 16, each in communication with the master node 12, but in some embodiments, the communication of data may also involve other vehicles (e.g., either directly with each other, with the combine harvesters 16, with the master node 12, or any combination thereof).

Note that the master node 12 determines the plan (e.g., and hence just-in-time waylines) for each of the combine harvesters 16 according to well-known information pertinent to planning the work order for the field. Some example parameters relevant to planning include customer (or owner) wayline orientation preferences (e.g., a preferred and/or historical direction of traversal), slope (e.g., runoff conditions or considerations), fuel economy (e.g., minimizing distance and/or turns), history (e.g., historical considerations, such as how the field was worked in prior operations, including traversing in the same manner that the crop material was planted). Other planning considerations include adjusted, just-in-time wayline communications to any support vehicles (e.g., tractors plus trailers, such as for providing support for the combine harvesters 16), such as offsets in distance for receiving harvested crop materials from the combine harvesters 16.

The network 14 may include a wide area network, such as the Internet 18, and local area networks 20 and 22, such as a radio frequency (RF) network, cellular network, WiFi, WiMax, among others. For instance, the master node 12 may be coupled to the Internet 18 via a network involving a wired connection (e.g., for FIG. 1A, such as a hybrid fiber coaxial (HFC), fiber optics, copper, etc.) or a wireless connection (e.g., for FIGS. 1B-1C, such as WiFi, or in some embodiments of FIG. 1A where network 20 is omitted), among other types of configurations. The network 22 may involve a wireless medium, which may include in some embodiments, an intermediate device or devices that may or may not use an intervening wired medium.

The combine harvesters 16A-16C comprise at least in part well known components. For instance, and referring to combine harvester 16A (with the same or similar applicability to combine harvesters 16B-16C, among others described herein), the combine harvester 16A has a single axial flow processing system 24 that extends generally parallel with the path of travel of the machine. However, though depicted with axial flow, some embodiments may use dual axial flow, transverse flow, hybrid flow, among others. Further, as explained previously, the type of agricultural machine used is not limited to combine harvesters 16, and hence other agricultural machines (towed or self-propelled) may be used in some embodiments. Further, the types of agricultural machines in a given field may vary as well. As well understood by those skilled in the art, the combine harvester 16A includes a harvesting header (not shown) at the front of the machine that delivers collected crop materials to the front end of a feeder house 26. Such materials are moved upwardly and rearwardly within the feeder house 26 by a conveyer 28 until reaching a beater 30 that rotates about a transverse axis. The beater 30 feeds the material upwardly and rearwardly to a rotary processing device, in this instance to a rotor having an infeed auger 32 on the front end thereof. The auger 32, in turn, advances the materials axially into the processing system 24 for threshing and separating. In other types of systems, the conveyor 28 may deliver the crop material directly to a threshing cylinder.

Generally speaking, the crop material entering the processing system 24 moves axially and helically there through during threshing and separating. During such travel the crop materials are threshed and separated by the rotor operating in cooperation with preferably foraminous processing members of a rotor cage 34 having well-known threshing concaves and separator grate assemblies, with the grain escaping laterally through the concaves and grate assemblies into a cleaning mechanism 36. Bulkier stalk and leaf materials are retained by the concaves and grate assemblies and are impelled out the rear of processing system 24 and ultimately out of the rear of the machine 16A. A blower (or equivalently, a fan) 38 forms part of the cleaning mechanism 36 and provides a stream of air throughout the cleaning region below processing system 24 and directed out the rear of the machine so as to carry lighter chaff particles away from the grain as it migrates downwardly toward the bottom of the machine to a clean grain auger 40. The clean grain auger 40 delivers the clean grain to an elevator (not shown) that elevates the grain to a storage bin 42 on top of the machine, from which it is ultimately unloaded via an unloading spout 44. A returns auger 46 at the bottom of the cleaning region is operable in cooperation with other mechanism (not shown) to reintroduce partially threshed crop materials into the front of processing system 24 for an additional pass through the system. The above-described operations of the combine harvester 16A are for illustrative purposes, and as should be appreciated by one having ordinary skill in the art, operations may differ among types of combine harvesters 16, those variations contemplated to be within the scope of the disclosure.

Referring now to FIG. 1B, shown is an embodiment of a dynamic planning system 10B, where the master node 12 (shown schematically in the cab of the combine harvester 16D, but not limited to that location) is integrated into one of the combine harvesters 16 in the field, such as combine harvester 16D. In other words, the combine harvester 16D is configured as a master and the remaining combine harvesters 16A-16C are in slave configurations. In some embodiments, the master node 12 may reside in the field in another location, such as in a storage shed in the field. In one embodiment, the master node 12 communicates the just-in-time wayline segments (and receives status updates) over a local network 22, which is configured as a wireless medium such as a radio frequency network, among other types of wireless media. The master node 12 operates as described in association with FIG. 1A, and hence discussion of the same is omitted here for brevity. In some embodiments, the planning for the field may initially be prepared remotely and transmitted to the master node 12 (or in some embodiments, be manually transferred via a removable storage device, such as a memory stick).

FIG. 1C shows an embodiment of a dynamic planning system 10C embodied in as ad hoc network. In this embodiment, the combine harvesters 16A-16D are configured as slaves, with the master node 12 integrated within the combine harvester 16E. In the ad hoc network, rather than having the work completed data (e.g., status updates) be communicated back to the master node 12 from each combine harvester 16 (and then communicated to each respective combine harvester 16 from the master node 12), the work completed data may be shared in peer-to-peer fashion among all of the combine harvesters 16A-16E over respective local networks 22 (e.g., 22A-22G). In some embodiments, a hybrid of two or more of the aforementioned topologies may be implemented.

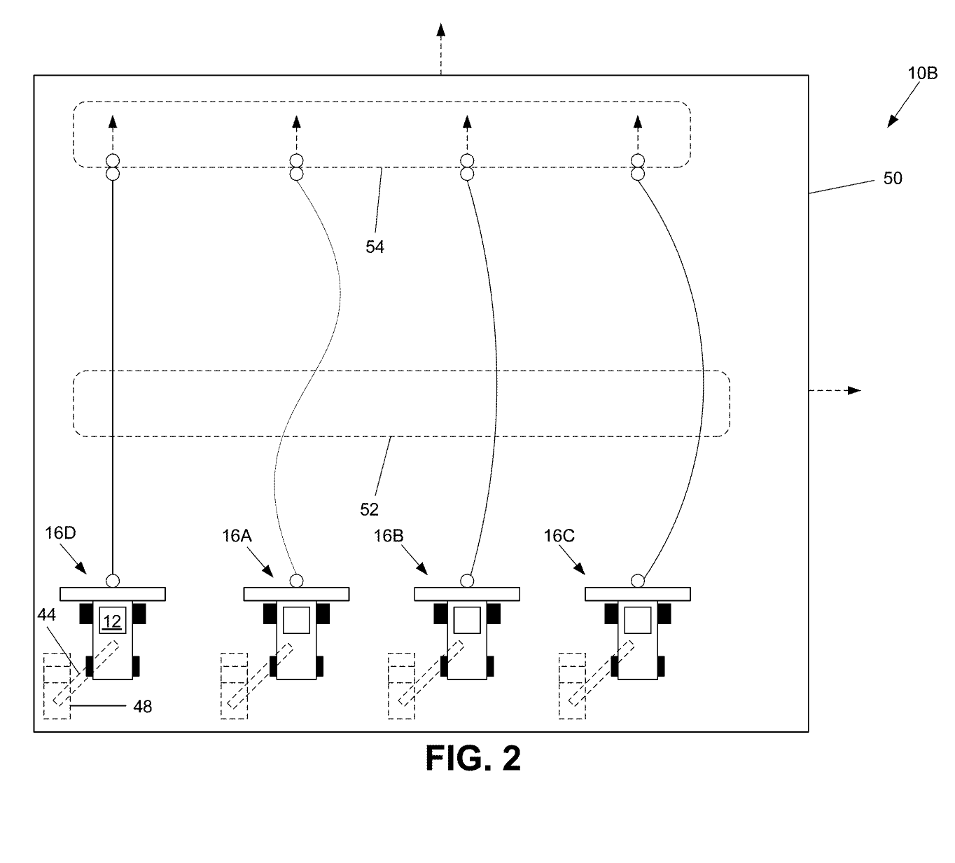

Having described some example network topologies that may be used to communicate just-in-time waylines and status updates, attention is directed to FIG. 2, which illustrates an embodiment of the dynamic planning system 10B of FIG. 1B, with the understanding that a similar manner of operation is involved in the other dynamic planning systems 10 of FIGS. 1A and 1C. As shown (and previously described), the dynamic planning system 10B comprises a plurality of combine harvesters 16A-16D. In the depicted embodiment, the combine harvester 16D comprises the master node 12. Also shown, in phantom (signifying their optional use), are vehicles (e.g., tractor-trailers), such as vehicle 48, that receive the harvested crop material from the respective combine harvesters 16 via the respective uploading spouts, such as unloading spout 44 for combine harvester 16D. Note that some embodiments may use fewer or additional vehicles 48. As noted above, the vehicles 48 may wireless receive just-in-time wayline segments, even though such vehicles are not involved in primary operations, to optimize their paths. For instance, each tractor-trailer 48 may receive adjusted, just-in-time wayline segments (e.g., to maintain a parallel path and offset) to keep up with the associated combine harvester 16 while the combine harvester 16 unloads. In the depicted embodiment, the combine harvesters 16 traverse a field 50 according to a set of just-in-time wayline segments 52 (e.g., as communicated by the master node 12, though in some embodiments, the master node 12 may be located remotely). The just-in-time wayline segments 52 are independently configured in one embodiment, and hence there may be curved paths and straight paths. For instance, the curved paths may be due to obstacles or sensitive areas in the field 50. Though depicted as proximal to each other, the distance between each combine harvester 16 may be further apart. In one embodiment, the just-in-time wayline segments 52 may be communicated initially from the master node 12 proximal in time (e.g., simultaneously, or close in time) to the combine harvesters 16, though not limited to a simultaneous communication. In one embodiment, the combine harvesters 16A-16C continuously (or in some embodiments, regularly or periodically) provide status updates to the master node 12 (the master node 12 also monitoring operations of the combine harvester 16D), which enables the master node 12 to determine the progress toward completion of the just-in-time wayline segments 52. In some embodiments, the status updates may be transmitted by the combine harvesters 16A-16C aperiodically, such as in response to a condition (e.g., inoperable machine) or event (e.g., nearing completion of the assigned just-in-time wayline 52, such as a threshold distance or time until completion of that segment). In either case, the master node 12 determines the next round of yet-un-assigned (and in some embodiments, presently undefined) just-in-time segments 54 based on the status updates. It should be appreciated that, though the status updates or the just-in-time wayline segments 52 or 54 may be communicated proximally in time, this is not a limitation. For instance, though proper planning and ideal conditions may result in just-in-time wayline segments 52, 54 or status updates being sent (or for status updates, received) proximally in time, some embodiments may have such communications staggered over time among all or a portion of the plurality of combine harvesters 16.

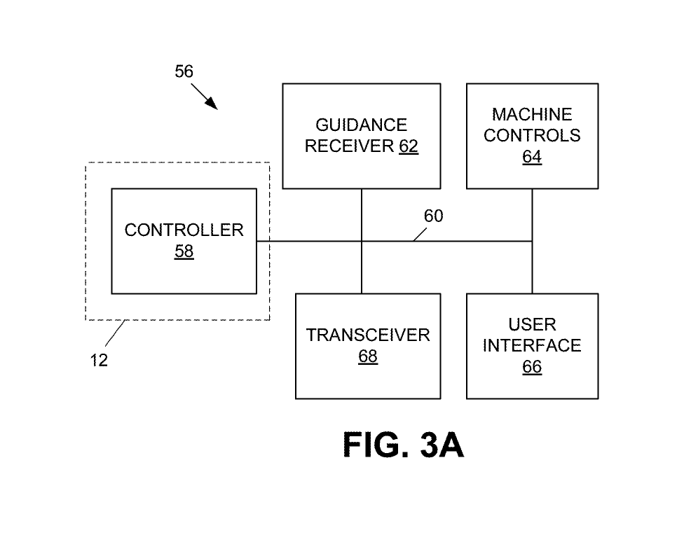

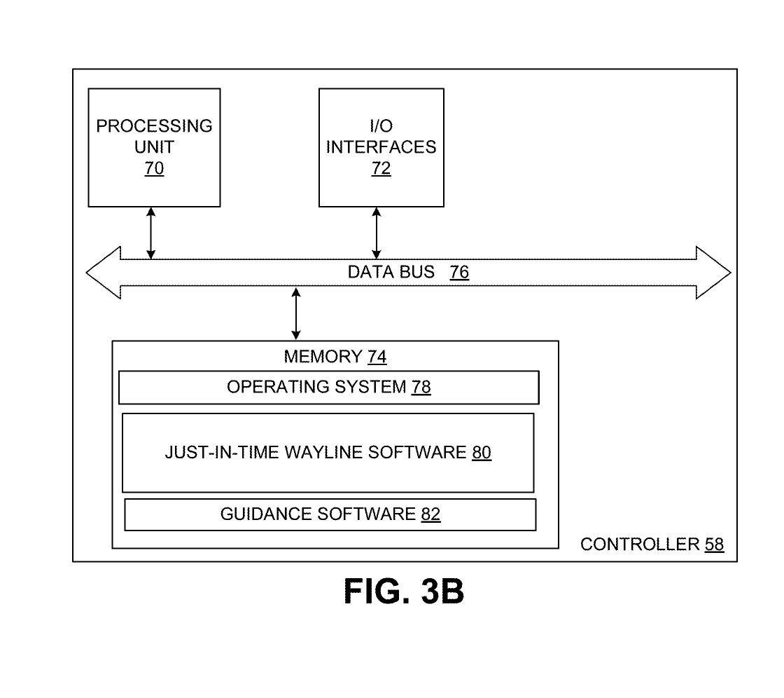

Attention is now directed to FIG. 3A, which illustrates a control system 56 that may be used in a dynamic planning system 10 (FIGS. 1A-1C). It should be appreciated within the context of the present disclosure that some embodiments may include additional components or fewer or different components, and that the example depicted in FIG. 3A is merely illustrative of one embodiment among others. Further, in some embodiments, the same or similar architecture depicted in FIG. 3A may be used in each agricultural machine, such as in each of the combine harvesters, and in some embodiments, other vehicles, such as vehicle 48. The control system 56 comprises a controller 58, which in one embodiment, may be configured as the master node 12. The controller 58 is coupled in a network 60 (e.g., a CAN network or other network, and not limited to a single network) to a guidance receiver 62 (e.g., which includes the ability to access one or more constellations jointly or separately), machine controls 64, a user interface 66, and a transceiver 68. The machine controls 64 collectively comprise the various actuators, sensors, and/or subsystems residing on the combine harvester 16 (FIG. 1), including those used to control machine navigation (e.g., speed, direction (such as a steering system), etc.), implement (e.g., header or trailer) position, and/or control, internal processes, among others. The user interface 66 may be a keyboard, mouse, microphone, touch-type display device, joystick, steering wheel, or other devices (e.g., switches) that enable input by an operator. The guidance receiver 62, as is known, may enable autonomous or semi-autonomous operation of the combine harvester 16 in cooperation with the machine controls 64 and the controller 58 (e.g., via guidance software residing in the controller 58). The transceiver 68 enables wireless (and/or wired) communication with other transceivers, such as transceivers residing within the combine harvesters 16. The transceiver 68 may be coupled to the controller 58 over a wireless connection, or via a wired connection in some embodiments, such as via the network 60.

The controller 58 is configured to receive and process the information from the transceiver 68, the guidance receiver 62, and/or the user interface 66. For instance, the controller 58 may receive input from the user interface 66 such as to enable intervention of machine operation by the operator, to provide feedback of a change in speed or direction and/or or an impending change or need or recommendation for change. In some embodiments, the controller 58 may receive input from the machine controls 64 (e.g., such as to enable feedback as to the position or status of certain devices, such as a header height and/or width, and/or speed, direction of the combine harvester 16, etc.). The controller 58 is also configured to cause the wireless transmission of information via the transceiver 68, or wired or wireless communication of control signals to the machine controls 64 and/or user interface 66 (e.g., to display or otherwise operational updates or alerts).

FIG. 3B further illustrates an example embodiment of the controller 58. One having ordinary skill in the art should appreciate in the context of the present disclosure that the example controller 58 is merely illustrative, and that some embodiments of controllers may comprise fewer or additional components, and/or some of the functionality associated with the various components depicted in FIG. 3B may be combined, or further distributed among additional modules, in some embodiments. It should be appreciated that, though described in the context of residing in an agricultural machine such as a combine harvester 16, in some embodiments, the controller 58 or its corresponding functionality may be implemented in a computing device located outside of the field. Referring to FIG. 3B, with continued reference to FIG. 3A, the controller 58 is depicted in this example as a computer system, but may be embodied as a programmable logic controller (PLC), FPGA, among other devices. It should be appreciated that certain well-known components of computer systems are omitted here to avoid obfuscating relevant features of the controller 58. In one embodiment, the controller 58 comprises one or more processing units, such as processing unit 70, input/output (I/O) interface(s) 72, and memory 74, all coupled to one or more data busses, such as data bus 76. The memory 74 may include any one or a combination of volatile memory elements (e.g., random-access memory RAM, such as DRAM, and SRAM, etc.) and nonvolatile memory elements (e.g., ROM, hard drive, tape, CDROM, etc.). The memory 74 may store a native operating system, one or more native applications, emulation systems, or emulated applications for any of a variety of operating systems and/or emulated hardware platforms, emulated operating systems, etc. In some embodiments, the memory 74 may store one or more field maps that were recorded from a prior traversal of a given field, enabling autonomous (or semi-autonomous) traversal of a given field when activated. In the embodiment depicted in FIG. 3B, the memory 74 comprises an operating system 78, just-in-time wayline software 80, and guidance software 82. It should be appreciated that in some embodiments, additional or fewer software modules (e.g., combined functionality) may be employed in the memory 74 or additional memory. In some embodiments, a separate storage device may be coupled to the data bus 76, such as a persistent memory (e.g., optical, magnetic, and/or semiconductor memory and associated drives).

The just-in-time wayline software 80 enables the determination, generation and delivery of just-in-time wayline segments and the processing of associated status updates. In some embodiments, the just-in-time wayline software 80 enables the preparation of a field plan from which the just-in-time wayline segments are generated (e.g., based on recorded data points from a prior traversal of the field along with parameters associated with environmental conditions and machine parameters for machines to be used for farming the field). In some embodiments, the just-in-time wayline software 80 processes a field plan developed elsewhere and loaded into memory 74, from which the just-in-time wayline segments are generated. The just-in-time wayline software 80 cooperates with the guidance software 82. The guidance software 82 may coordinate inputs from the guidance receiver 62 and output control signals to one or more machine controls 64 to enable guided traversal and/or performance of various farming operations on a field based on input from the just-in-time wayline software 80. In some embodiments, the functionality (e.g., code) of the just-in-time wayline software 80 may be embodied in the guidance software 82, and in some embodiments, the functionality (e.g., code) of the guidance software 82 may be embodied in the just-in-time wayline software 80.

Execution of the software modules 80 and 82 may be implemented by the processing unit 70 under the management and/or control of the operating system 78. In some embodiments, the operating system 78 may be omitted and a more rudimentary manner of control implemented. The processing unit 70 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the controller 58.

The I/O interfaces 72 provide one or more interfaces to the network 60 and other networks. In other words, the I/O interfaces 72 may comprise any number of interfaces for the input and output of signals (e.g., analog or digital data) for conveyance over the network 60. The input may comprise input by an operator (local or remote) through the user interface 66 (e.g., a keyboard, joystick, steering wheel, or mouse or other input device (or audible input in some embodiments)), and input from signals carrying information from one or more of the components of the control system 56, such as the guidance receiver 62, machine controls 64, and/or the transceiver 68, among other devices.

When certain embodiments of the controller 58 are implemented at least in part as software (including firmware), as depicted in FIG. 3B, it should be noted that the software can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiment of the controller 58 are implemented at least in part as hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

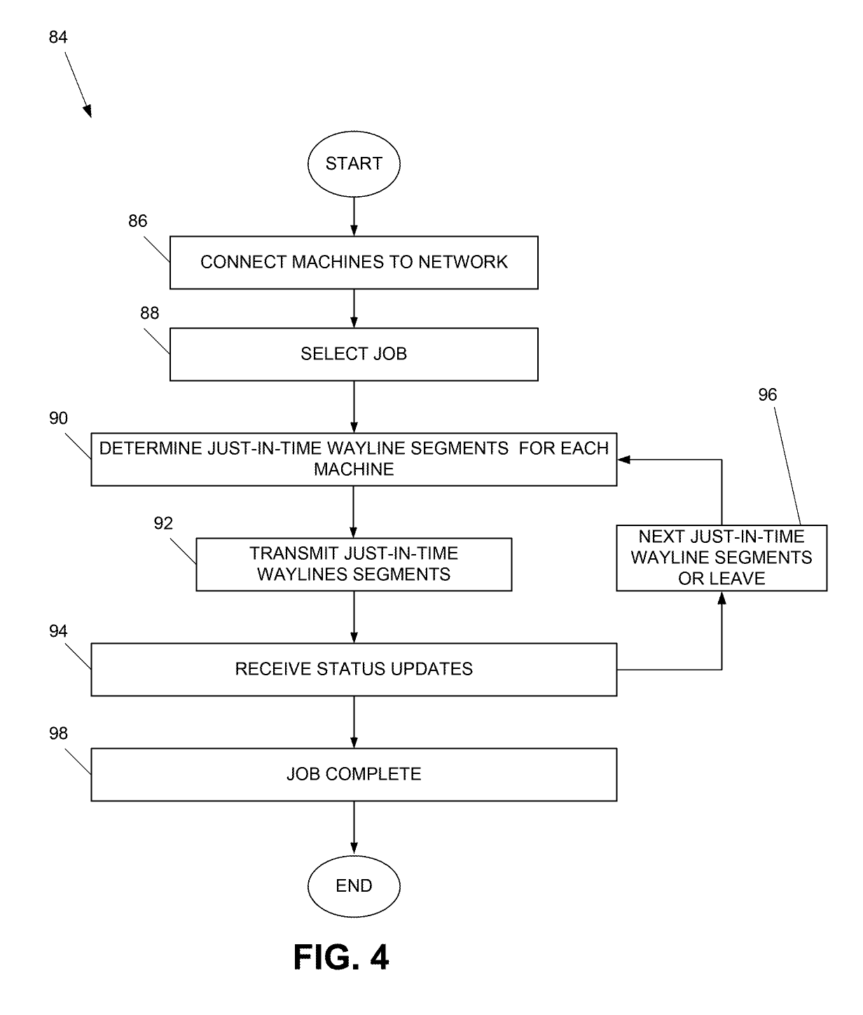

Attention is directed now to FIG. 4, which illustrates one method embodiment of a dynamic planning system, and is denoted as method 84. In one embodiment of the method 84, multiple agricultural machines enter a field with an objective of cooperatively working the field to completion. For instance, upon entering the field, each agricultural machine connects with the master node via the network (86). As noted above, the master node may be remotely located relative to the field (e.g., and communicatively coupled to the agricultural machines via a network), or located within the field (e.g., on one of the agricultural machines or elsewhere in the field and designated as a master). A job for the field is selected (88), and just-in-time wayline segments are determined for each agricultural machine (90). For instance, the master node may designate just-in-time wayline segments to each of the agricultural machines in a given fleet assigned to the field. The master node communicates (e.g., via a transceiver) the just-in-time wayline segments to the agricultural machines (92). As each agricultural machine fulfills its task according to a designated wayline, it communicates progress updates to the master node (94). Such communications may be regular or irregular (e.g., based on certain conditions or events), or a mix of both. Based on the status updates associated with the progress and/or other conditions or events, the master node determines the next just-in-time waylines for the plurality of agricultural machines still in operation (96). In other words, in some instances, an agricultural machine may go down (or an operator may break for one reason or another), and the agricultural machine may leave the pool of agricultural machines (e.g., temporarily or for at least a duration beyond completion of the tasks of the field), and just-in-time waylines may be determined for the remaining agricultural machines (and in some embodiments, additional agricultural machines, such as those used for backup) (90), and the process (90-96) continues until the status updates (94) reveal that collectively, the agricultural machines have completed the tasks involved for the field, at which time the job is complete (98) and processing ends.

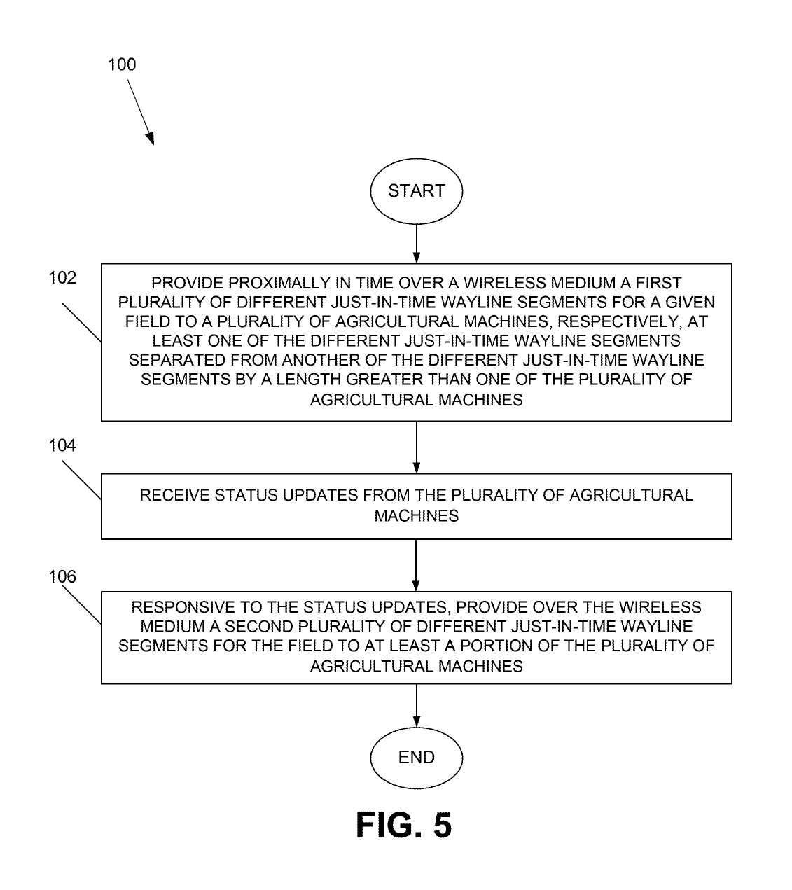

Having described certain embodiments of a dynamic planning system and method, it should be appreciated within the context of the present disclosure that another embodiment of dynamic planning method, denoted as method 100 as illustrated in FIG. 5, comprises providing proximally in time over a wireless medium a first plurality of different just-in-time wayline segments for a given field to a plurality of agricultural machines, respectively, at least one of the different just-in-time wayline segments separated from another of the different just-in-time wayline segments by a length greater than one of the plurality of agricultural machines (102); receiving status updates from the plurality of agricultural machines (104); and responsive to the status updates, providing over the wireless medium a second plurality of different just-in-time wayline segments for the field to at least a portion of the plurality of agricultural machines (106).

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A method, comprising:
providing proximally in time over a wireless medium a first plurality of different just-in-time wayline segments for a given field to a plurality of agricultural machines, respectively, at least one of the different just-in-time wayline segments separated from another of the different just-in-time wayline segments by a length greater than one of the plurality of agricultural machines;
receiving status updates from the plurality of agricultural machines; and
responsive to the status updates, providing over the wireless medium a second plurality of different just-in-time wayline segments for the field to at least a portion of the plurality of agricultural machines.

2. The method of claim 1, further comprising, prior to the providing of the first plurality of different just-in-time wayline segments, determining a plan for performing operations on the field.

3. The method of claim 2, wherein determining the plan is based on a quantity of the agricultural machines and their respective characteristics.

4. The method of claim 3, wherein determining the plan is further based on a one or more of customer wayline orientation preference, topography of the field, fuel economy, or historical field operations.

5. The method of claim 1, wherein receiving the status updates comprises receiving information corresponding to progress of each of the plurality of agricultural machines in performing a task associated with the provided first plurality of different just-in-time wayline segments.

6. The method of claim 1, wherein receiving the status updates comprises receiving an indication that one of the plurality of agricultural machines is inoperable.

7. The method of claim 6, wherein providing the second plurality of different just-in-time wayline segments comprises re-assigning one of the plurality of agricultural machines to complete one of the first plurality of different just-in-time wayline segments previously assigned to the one of the plurality of agricultural machines that is inoperable.

8. The method of claim 1, wherein receiving the status updates comprises receiving an indication that one of the agricultural machines deviated from one of the first plurality of different just-in-time wayline segments.

9. The method of claim 8, wherein providing the second plurality of different just-in-time wayline segments comprises re-assigning one of the plurality of agricultural machines to complete the one of the first plurality of different just-in-time wayline segments previously assigned to the one of the plurality of agricultural machines that deviated from the one of the first plurality of different just-in-time wayline segments.

10. The method of claim 1, wherein receiving the status updates comprises receiving status updates associated with one or more additional vehicles that are associated with the plurality of agricultural machines, and further comprising providing the second plurality of different just-in-time wayline segments and a respective offset to the at least a portion of the plurality of agricultural machines, the second plurality of different just-in-time wayline segments and the respective offset provided by the at least a portion of the plurality of agricultural machines to the one or more additional vehicles.

11. The method of claim 1, wherein receiving the status updates comprises receiving status updates associated with one or more additional vehicles that are associated with the plurality of agricultural machines, and further comprising providing the second plurality of different just-in-time wayline segments and a respective offset to either the one or more additional vehicles, the at least a portion of the plurality of agricultural machines, or a combination of both the one or more additional vehicles and the at least a portion of the plurality of agricultural machines.

12. The method of claim 1, further comprising receiving additional status updates from one or more additional vehicles that are associated with the plurality of agricultural machines, and further comprising providing the second plurality of different just-in-time wayline segments and a respective offset to either the one or more additional vehicles, the at least a portion of the plurality of agricultural machines, or a combination of both the one or more additional vehicles and the at least a portion of the plurality of agricultural machines.

13. The method of claim 1, further comprising wirelessly communicating the received status updates with the plurality of agricultural machines.

14. The method of claim 1, further comprising providing a report for work completed by the plurality of agricultural machines.

15. The method of claim 1, wherein the providing of the first and second plurality of different just-in-time wayline segments, and the receiving of the status updates, is performed from an apparatus located remotely from the field.

16. The method of claim 1, wherein the providing of the first and second plurality of different just-in-time wayline segments, and the receiving of the status updates, is performed from an agricultural machine traversing the field along with the plurality of agricultural machines.

17. An agricultural machine, comprising:
a chassis coupled to rotating elements to cause traversal across a field;
a transceiver; and
a controller configured to:
cause a first plurality of different just-in-time wayline segments for a given field to be transmitted by the transceiver over a wireless medium to a plurality of agricultural machines, respectively, at least one of the different just-in-time wayline segments determined independently from another of the different just-in-time wayline segments;
receive status updates from the plurality of agricultural machines via the transceiver; and
responsive to the status updates, cause a second plurality of different just-in-time wayline segments for the field to be transmitted by the transceiver over the wireless medium to at least a portion of the plurality of agricultural machines.

18. The agricultural machine of claim 11, wherein the controller is further configured to, prior to the causing of the transmission of the first plurality of different just-in-time wayline segments, receive a plan for all of the agricultural machines in the field to follow in the field.

19. The agricultural machine of claim 11, wherein the controller is further configured to, prior to the causing of the transmission of the first plurality of different just-in-time wayline segments, coordinate operations associated with the first plurality of different just-in-time wayline segments among all of the agricultural machines on the field.

20. A system, comprising:
a first agricultural machine comprising a first controller and a first transceiver; and
plural second agricultural machines, each comprising a respective controller and respective transceiver, wherein for a given field, the first controller is configured to implement and cause transmission via the first transceiver of just-in-time wayline segments to the plural controllers of the plural second agricultural machines, wherein the progress of performing all farming tasks associated with the just-in-time wayline segments is wirelessly shared among all of the controllers according to an ad-hoc network prior to the first controller causing the transmission via the first transceiver of a second set of just-in-time wayline segments.
